(19) United States
(12) Patent Application Publication
(10) Pub. No.: US 2015/0332655 A1
(43) Pub. Date: Nov. 19, 2015

(54) METHOD AND APPARATUS FOR DETECTING VISIBLE AMBIENT LIGHT

(71) Applicant: FLATFROG LABORATORIES AB, Lund (SE)

(72) Inventors: Mattias KRUS, Lund (SE); Ola WASSVIK, Brosarp (SE); Ivan KARLSSON, Lund (SE)

(73) Assignee: FLATFROG LABORATORIES AB, Lund (SE)

(21) Appl. No.: 14/758,120

(22) PCT Filed: Dec. 23, 2013
(86) PCT No.: PCT/SE2013/051614

§ 371 Date: Jun. 26, 2015

Related U.S. Application Data
(60) Provisional application No. 61/746,278, filed on Dec. 27, 2012.

(30) Foreign Application Priority Data
Dec. 27, 2012 (SE) 1251512-8

(51) Int. Cl. G09G 5/10; G06F 3/042; G09G 5/18

(52) U.S. Cl. CPC G09G 5/10; G09G 5/18; G06F 3/042; G09G 2360/144; G09G 2330/021

(57) ABSTRACT

Method and touch-sensitive apparatus for determining the amount of visible ambient light incident on the touch-sensitive apparatus comprising a first array of light-sensing elements, the method comprising receiving light signals at a plurality of light-sensing elements in the first array; converting the light signals into electrical signals, identifying at least one type of ambient light source from the signal by comparing features in the signal with characteristic features of one or more known light sources and obtaining information related to the amount of visible ambient light incident on the panel generated by the at least one type of ambient light source in relation to the amount of ambient light registered at the plurality of light-sensing elements.

### CROSS-REFERENCE TO RELATED APPLICATIONS

The present application claims the benefit of Swedish patent application No. 1251512-8, filed 27 Dec. 2012, and U.S. provisional application No. 61/746,278, filed 27 Dec. 2012.

### TECHNICAL FIELD

The present invention relates to a method and apparatus for determining the amount of visible ambient light on a touch-sensitive apparatus. In particular, the apparatus for determining the visible ambient light comprises a first array of light-sensing elements.

### BACKGROUND

Light sensors can be found in a large variety of applications today, most notably in consumer electronics. Their function is to detect the amount of light falling onto a display. Using the backlight function of the display, the brightness of the display can then be adjusted in relation to the amount of light detected.

Ambient light sensors are sensitive to visible light and the backlight power of a display is often made proportional to the amount of visible light falling onto the display.

Present day example solutions in detecting ambient light sources are described in documents US2011248170A1, US20110025661A1 and KR20030033832.

US2011248170 deals with a system for detecting the amount of visible light from one or more ambient lights sources analyzing the light signal received by a photodiode comprising an IR-sensitive light-sensing element stacked on top of a detector sensitive to visible light. The IR-sensitive element is constructed to be transparent to visible light. By calculating the ratio of the light intensities incident on the stacked light-sensing element the type of ambient light source can be characterized. One disadvantage of the solution is that it requires a specially constructed light-sensing element to work properly. Also, it is dependent on detection of both infrared and visible light for determining the type of ambient light source.

A different solution is disclosed in US20110025661A1, where it is attempted to characterize the ambient light source by focusing on the source voltage driving the ambient light source. Light from one or more ambient light sources is gathered from a number of light-sensing elements during several overlapping intervals, which are chosen to match one or more periods for known power sources driving ambient lighting. Integrating a signal over several of these periods reduces the influence of the power source signal when compensating for ambient light falling on the detectors. One disadvantage of this solution is that it cannot distinguish ambient light sources driven by the same power supply.

Finally, in the Korean patent application KR20030033832, a color content of the registered visible light from an ambient light source is analyzed and used to compensate the white balance of an image produced by a digital camera. It is to be noted that the solution requires ambient sensors sensitive to visible light and does not use the information obtained to compensate for the brightness of a display, but rather color fidelity of a captured image.

There is thus a need for a simple, cost-effective way of characterizing one or more ambient light sources in order to be able to provide accurate information for e.g. controlling the brightness of a display unit.

### SUMMARY

A solution to at least some of the problems encountered in known technology is provided by the invention according to independent claims.

Preferable embodiments of the solution according to the present invention are presented in the dependent claims.

According to one aspect of the present invention the solution is provided by a method for determining the amount of visible ambient light on a touch-sensitive apparatus comprising a first array of light-sensing elements. The method according to one aspect of the invention comprises receiving light signals at a plurality of light-sensing elements in the first array, converting the light signals into electrical signals, identifying at least one type of ambient light source from the signal by comparing features in the signal with characteristic features of one or more known light sources and obtaining information related to the amount of visible ambient light incident on the panel generated by the at least one type of ambient light source in relation to the amount of ambient light registered at the plurality of light-sensing elements.

According to another aspect of the present invention, the solution to at least some of the problems mentioned earlier is given by a method for determining the visible ambient light level incident on a touch-sensing apparatus comprising a light transmissive panel defining a touch surface and an opposite surface, where light generated by an illumination arrangement comprising emitters propagates in the panel by total internal reflection. The method comprising receiving light signals at a plurality of light-sensing elements in a first array belonging to the touch-sensing apparatus, converting the light signals into electrical signals, identifying at least one type of ambient light source from the signal by comparing features in the signal with characteristic features of one or more known light sources and obtaining information related to the amount of visible ambient light generated by the at least one type of ambient light source identified which is incident on the panel.

The method according to the present invention has the advantage that it can use existing light detectors to identify one or more ambient light sources accurately. These existing light detectors may also be used in a touch-sensitive apparatus for detecting touches onto a surface of a transparent panel in which light transmitted by light-emitting elements propagates through total internal reflection and where a touch onto the surface introduces disturbances to the reflection of the light which after detection by the light detectors can be detected as touches. Hence, dedicated ambient light sensors which would add to the cost of a touch-sensitive apparatus are not needed. Once the one or more ambient light sources are identified, this information may be used to calculate a corresponding brightness value for a transmissive panel onto which the ambient light is incident and to adjust the brightness to make the information displayed on the panel readable by a user.

According to another aspect of the present invention, the solution is given by a touch-sensitive apparatus for determining the amount of visible ambient light incident onto a touch-sensitive panel. The apparatus comprises a first array of light-sensing elements configured to convert incident ambient light signals into electrical signals, a memory unit configured to store characteristic signal features for a plurality of known ambient light sources and a processor configured to identify at least one type of ambient light source from the signal by comparing features in the signal with the stored characteristic signal features of the one or more known light sources and wherein the processor is further configured to relate the amount of visible ambient light incident on a touch-sensitive panel of the apparatus generated by the ambient light source identified by the processor.

According to yet another aspect of the present invention, the solution is given by a touch-sensitive apparatus for determining the amount of visible ambient light incident onto the apparatus. The apparatus comprises a light transmissive panel defining a touch surface and an opposite surface, an illumination arrangement comprising emitters configured to generate light into the panel, such that light is propagated in the panel by total internal reflection, a first array of light-sensing elements configured to receive the light generated by the emitters and ambient light incident onto the touch surface of the panel and to convert the incident ambient signals light into electrical signals, a memory unit configured to store characteristic signal features for a plurality of known ambient light sources. The touch-sensitive apparatus further comprises a processor configured to identify at least one type of ambient light source from the signal by comparing features in the signal with the stored characteristic signal features of the one or more known light sources and wherein the processor is further configured to relate the amount of ambient light received by the plurality of light-sensing elements to the amount of visible ambient light incident on the transmissive panel and generated by the ambient light source identified.

Having the advantages listed for the method according to the present invention earlier in the description, these same advantages also apply to the touch-sensitive apparatus according to the present invention.

### BRIEF DESCRIPTION OF THE DRAWINGS

FIG. 1 displays a known touch-sensitive apparatus according to known technology in a top view.

FIG. 2 displays the touch-sensitive apparatus in a sectional view.

FIG. 3 displays the touch-sensitive apparatus from FIG. 2 where ambient light is incident onto the apparatus.

FIG. 4 displays a spectral distribution of some known light sources in the visible and infrared spectrum.

FIGS. 5 and 6 display a time-domain representation of two common light source classes.

FIG. 7 displays a flow chart of one embodiment of a method according to the present invention.

### DETAILED DESCRIPTION

In the following detailed description a number of example embodiment of the present invention are given. These embodiments serve only to clarify the principles on which the present invention rests and should therefore not be construed as limiting the present invention to these embodiments exclusively. Ultimately, the present invention is only limited by the scope of the accompanying claims.

It should also be added that certain details not relevant to the explanation of the present invention have been omitted in the embodiments presented in the description below.

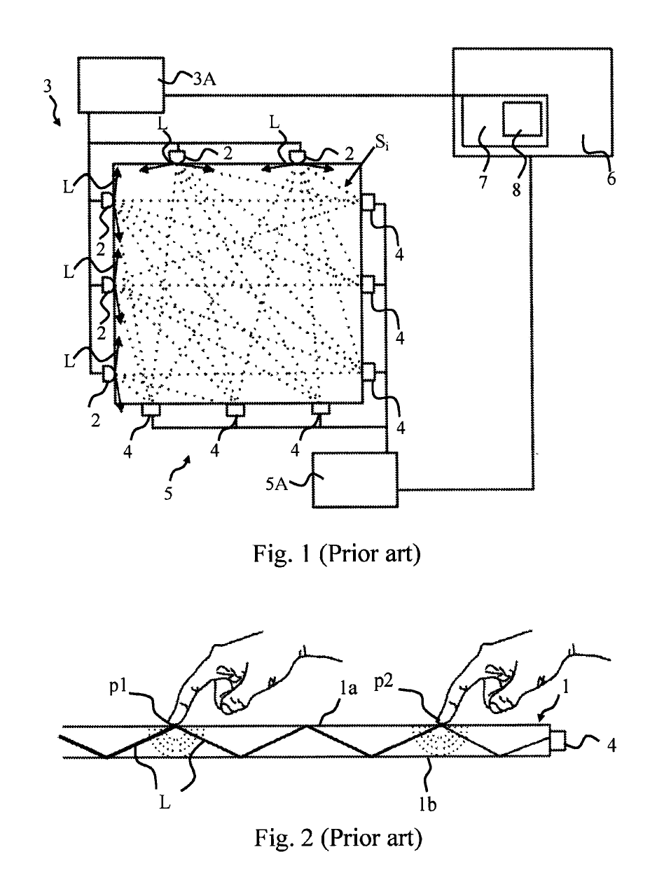

FIG. 1 displays a known touch-sensitive apparatus belonging to the applicant in a top view and described in detail in the published patent application WO 2011/139213 A1. The touch-sensitive apparatus comprises a panel 1, an illumination arrangement 3 comprising emitters 2 and an illumination control unit 3A, and a light detection arrangement 5 comprising detectors 4 and a detection control unit 5A. The touch-sensitive apparatus is according to one embodiment a multi-touch system, thus enabling detection of a multiplicity of touches. The emitters 2 introduce light L into the panel at in-coupling points, an in-coupling point defining a point on the panel 1 where light L from an emitter 2 enters the panel 1. The detectors 4 detect the energy of the light at out-coupling points, an out-coupling point defining a point on the panel where the light propagating in the panel 1 leaves the panel 1 for subsequent detection by a detector 4. It is only the in-coupling and out-coupling points of the detectors 4 and emitters 2, respectively, that have to be arranged along the periphery of the panel; the detectors 4 and emitters 2 may be arranged at a distance from the panel 1. Light may enter and leave the panel 1 through the edges of the panel 1, or through the top or bottom surface of the panel, e.g. by the use of an appropriate light coupling element. Moreover, the touch-sensitive apparatus comprises a control unit 6 configured to control the emission of light L propagating in the panel 1 and the collection of data from the detectors 4 via the detection control unit 5A. The control unit 6 may also be directly connected to the emitters 2 and the detectors 4. Also, the touch-sensitive apparatus comprises a mode selector 7 for selecting the emission pattern in dependence of occurrence of touches on the touch service. The mode selector 7 is not essential to the description of the invention and will not be elaborated further. The control unit also comprises a processor 8 which may include a memory (not shown) performing calculations used by the control unit 6 to control the function of the touch-sensitive apparatus.

In FIG. 2 the touch-sensitive apparatus from FIG. 1 is displayed in a sectional view. Light L from the emitter 2 is injected into the light transmissive panel 1 and propagates inside the panel 1 while being reflected in the top and bottom surfaces 1a, 1b. Light may be reflected by total internal reflection (TIR) at least in the top surface 1a which forms a touch surface. The bottom surface 1b may reflect the light by TIR, or by a reflective coating (not shown) applied to the bottom surface 1b. At some other end of the panel 1, the energy of the transmitted light is detected by the detector 4. In the event of an object touching the touch surface of the panel 1, the object interacts with the light beam inside the panel 1 and frustrates the TIR. Frustrated total internal reflection (FTIR), in which energy is dissipated into the object from an evanescent wave formed by the propagating light, provided that the object has a higher refractive index than the material surrounding the panel surface material and is placed within less than several wavelengths distance from the surface, may be used in the present invention. During the frustration of TIR, part of the light beam will be absorbed by the object, and another part will be reflected and/or scattered by the object. The remaining light beam will continue with total internal reflection as before but now attenuated due to the absorption, reflection and scattering, as illustrated in FIG. 2 with a slightly thinner line.

The apparatus detects touches p1, p2 on the top surface 1a by analyzing an ensemble of energy values determined for different detection lines Sᵢ. A detection line Sᵢ (illustrated by dotted lines in FIG. 1) is defined as the light path between one in-coupling and one out-coupling point, and an emitter 2 and a detector 4 at ends of a detection line are referred to as an emitter-detector pair.

The occurrence of one or more touches p1, p2 may be determined by identifying changes in the ensemble of energy values. To determine the position of a plurality of touches p1, p2 on the top surface 1a, the energy values for the detection lines are compared against a reference value for the respective detection line. The reference value may be an energy value measured at an earlier time. Alternatively the energy values may be converted into transmission values. Each detector 4 measures the energy dₜᵢ of the transmitted light for a particular detection line Sᵢ, and the reference value that the energy value dₜᵢ is compared with is a background energy value dᵤ for the detection line. The transmission value for detection line Sᵢ may be computed as, Tₜ=dₜᵢ/dᵤ. The transmission may alternatively also be computed as a difference value, Tₜ=dₜᵢ−dᵤ. Such a difference value may e.g. be used to quickly derive approximate touch data from the measured energy values.

The background energy value can be obtained by calibrating the touch sensitive apparatus at start up, i.e. by setting the background energy value dᵤ equal to the energy measured for detection line Sᵢ when no objects are touching the touch surface.

As illustrated in FIG. 2, the transmitted light may carry information about a plurality of touches. In an FTIR system, each touch point pₙ (corresponding to a touching object) has a transmission τₙ, which generally is in the range 0-1, but normally in the range 0.7-0.99. The total transmission T, along a detection line Sᵢ, is at least approximately given by the product of the individual transmissions tₙ of the touch points pₙ on that detection line: T=Πτ, (1)

For example, two touch points p₁ and p₂ with transmissions 0.9 and 0.8, respectively, on a detection line Sᵢ, yield a total transmission Tⱼ=0.72. The second touch point p₂ will attenuate a part of the light L that reaches the second touch point, hence the multiplication. With an FTIR setup it is thus possible to “see through” touches on the panel 1.

The entire touch-sensitive apparatus and the method of detecting touches on the surface of the apparatus are described in detail in the published patent application WO 2011/139213 A1 filed by the applicant which is hereby incorporated by reference.

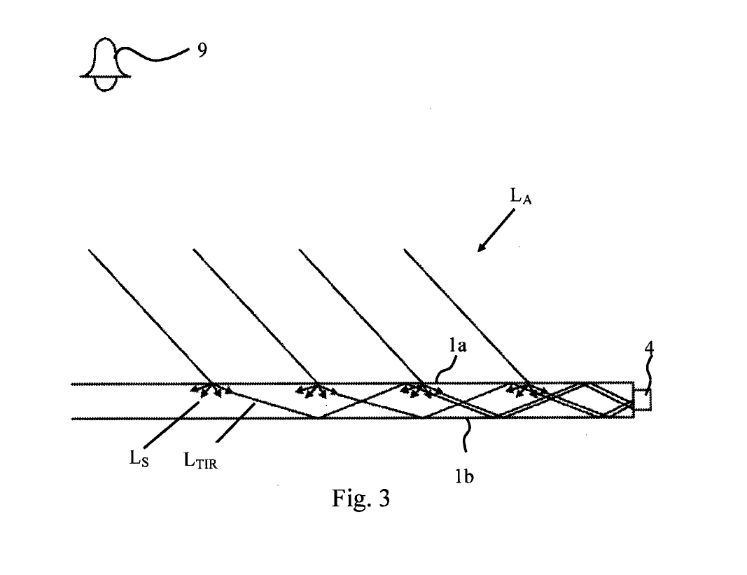

FIG. 3 displays the touch-sensitive apparatus from FIG. 2 where the emitters (not shown) have been switched off and only ambient light L_{A} is registered by the detector 4. We assume for the sake of simplicity that we have one ambient light source 9 such as a halogen lamp and that the light source 9 is located far away from the touch-sensitive panel 1. We thus assume that the ambient light rays L_{A} are incident parallel onto the upper panel surface 1a and that they are evenly distributed over the panel surface 1a. Ambient light L_{A} from the remote light source L_{A} will upon entry into the transmissive panel 1 be scattered, where a part of the scattered ambient light L_{S} will propagate in the transmissive panel 1 by total internal reflection. Totally internally reflect light is illustrated by the light rays L_{TIR} in FIG. 3. It is this part of the incident ambient light L_{A} that will be registered by the one or more detectors 4.

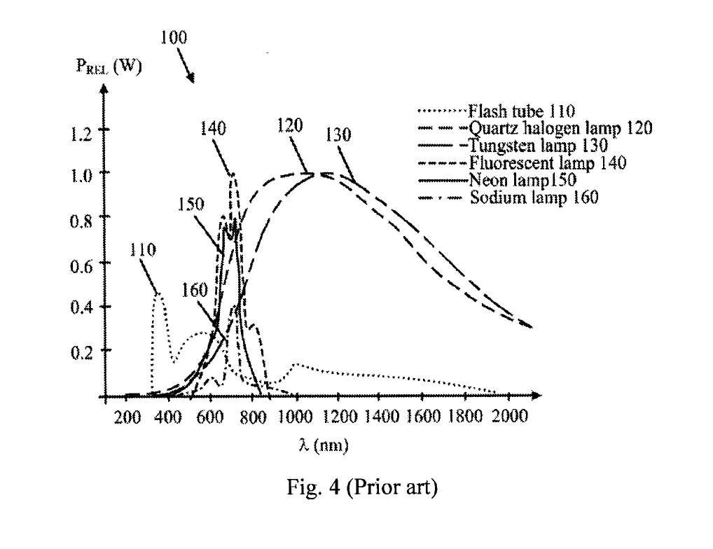

FIG. 4 displays a diagram over the spectral distribution of different ambient light sources as a function of the relative power produced by each ambient light source.

Looking at the dotted curve 110 which represents the spectral distribution of a flash tube, it is apparent that there are three distinct wavelength areas where the majority of the relative power is located—namely in the ultraviolet between about 300-400 nm, in the visible domain and moreover in the far-infrared region between about 1000-1900 nm. Hence, depending on the type of light-sensing element used and having in mind that most ambient light-sensing elements today are either sensitive to infrared or visible light, measuring only in the infrared domain will not give an accurate picture of the ambient light source in the visible domain.

This problem becomes even more pronounced when using infrared light-sensing elements having their peak sensitivity somewhere in the near-infrared region of the light spectrum. In that scenario, when receiving light from a quartz-halogen lamp 120 or a tungsten lamp 130, the light-sensing element will sense a large incident light-intensity (where it should be remembered that received power is proportional to the square of light intensity), while in reality, the intensity of the incident visible light for these ambient light sources is rather low.

A resultant controlling of the backlight or brightness of a display will most probably overcompensate for the incident ambient light if the brightness controlling mechanism is only relying upon the intensity of the received infrared light.

As evident from the figure, the majority of the light intensity or power produced by a quartz-halogen lamp 420 and a tungsten lamp 130 is in the infrared domain—i.e. the majority of the power is simply produced as heat radiation.

In contrast, a fluorescent lamp 140 as commonly used in office and factory buildings has essentially all of its power concentrated in the visible light spectrum with spectrum peaks around 600 and 700 nm.

A neon lamp 150 also has a similar spectral distribution as the fluorescent lamp.

As a side remark, a sodium lamp 160 has a majority of its spectral distribution in the visible domain with a power peak around 700 nm.

In contrast, light from a natural source (i.e., sun light) is more evenly distributed across the entire spectrum.

Thus, when using infrared light-sensing elements for detecting incident light it is important to bear in mind the different spectral distributions of different light sources and how they differ in the infrared and visible domain as illustrated in FIG. 1.

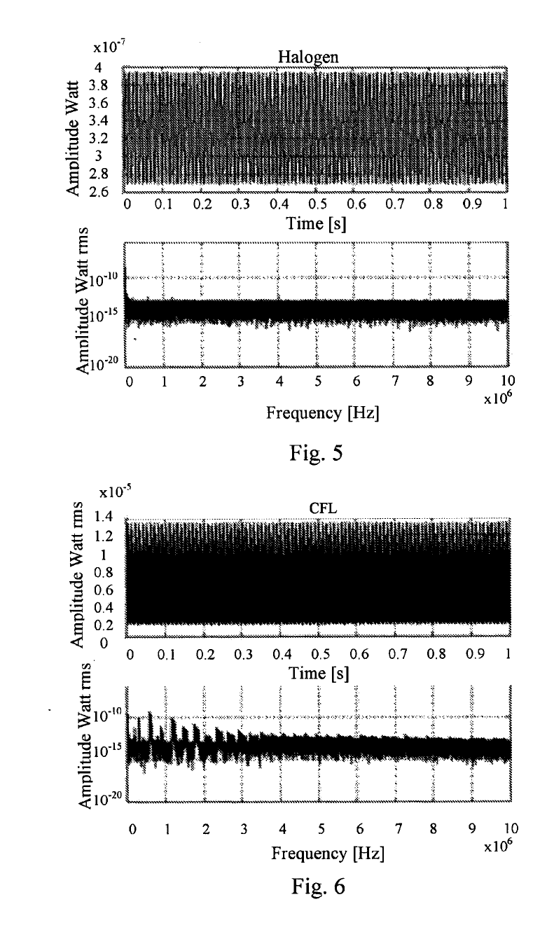

FIG. 5 displays a time- and frequency signature of a common halogen lamp. In the upper part of the figure the time domain output of the halogen lamp expressed in seconds is displayed as a function of amplitude expressed in Watts, The lower part of the figure displays the light output from the halogen lamp expressed as frequency in Hz in terms of amplitude expressed in W.

FIG. 6 displays the time- and frequency signature of an energy saving lamp (ESL) in the same fashion as in FIG. 5.

When comparing the two ambient light sources it is apparent that the time-domain behaviors differ significantly and that the halogen lamp oscillates with a lower frequency than the energy saving lamp. Furthermore, looking at the temporal frequency content of the two light sources it becomes apparent that the energy-saving lamp has a number of characteristic frequencies in the high frequency range, while the frequency spectrum of the halogen lamp is located at lower frequencies, corresponding to a rectified 50 Hz oscillation.

These different behaviors will be used further down in the description to identify the type or types of ambient light sources whose light has been detected by the detector 4.

Using FIGS. 1-3 as examples the present invention will be explained.

In FIG. 1 the plurality of detectors 4 are used to detect light L propagating inside the transmissive panel 1. In order for the detectors 4 to only measure ambient light L_{A} incident onto the upper surface 1a of the panel 1, the control unit 6 is configured to switch the emitters 2 off. As already explained earlier in FIG. 3, ambient light L_{A} incident onto the upper surface 1a of the panel 1 will be scattered into the panel, while part of the scattered ambient light will be detected by the plurality of detectors 4. In the embodiment in FIG. 1 it is assumed that the detectors are sensitive to infrared light, which is preferred, or to visible light. In case the detectors 4 are sensitive to visible light it is assumed that their sensitivity curves differ from those of the human eye. Moreover, while the detectors 4 are displayed as being arranged around the edge of the transmissive panel 1, they may also be arranged around the periphery of the upper surface 1a or the lower surface 1b of the transmissive panel 1.

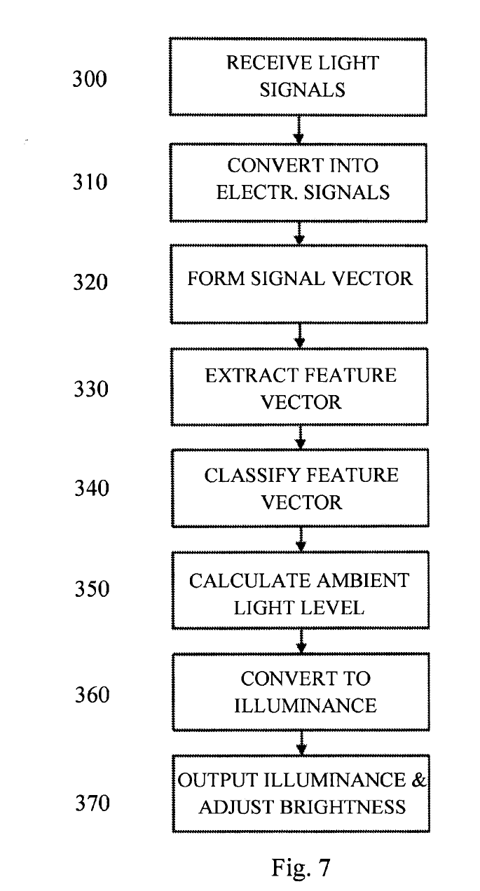

Now, output electrical signals corresponding to the light signals from one or more ambient sources are produced by each of the plurality of light-sensing elements 4 and received by the detector control unit 5A and from there sent further to the control unit 6. Moreover, the control unit 6 is configured to read out output values from the detectors 4 using the processor 8 form a signal vector representing ambient light signal received at each of the plurality of detectors 4. The processing unit 8, in turn, may comprise or is connected to a memory unit (not shown) configured to store a number of template vectors corresponding to different ambient light sources. Also, the processor 8 is configured to perform a correlation (or alternatively, a convolution) operation between the signal vector formed and the template vectors stored in the memory unit and thereby identify the type or types of ambient light source(s) detected by the plurality of detectors 4. The processor 8 may perform the identification by firstly extracting a feature vector from the correlation, convolution or other comparison operation between the signal and the template vectors and secondly by classifying the resultant feature vector according to a pattern recognition method which will be described more in detail in FIG. 7. Moreover, the control unit 6 is configured to instruct the processor 8 to calculate the level of ambient light incident on the upper surface 1a of the transmissive panel 1. The reason for this is that the plurality of detectors 4 only register a certain portion of the scattered ambient light L_{S}. One way to calculate the amount of ambient light incident onto the upper surface 1a of the panel is to assume that in the absence of contaminations on the upper panel surface 1a the amount of scattered incident ambient light L_{A} is known and can be modeled by a known relation stored in the memory unit connected or present in the processor 8. Using this relation (which may or may not be linear) the control unit 6 may finally determine the amount of ambient light incident onto the panel. However, if the detectors 4 are only sensitive to infrared light it will be necessary for the control unit 6 to instruct the processor 8 to calculate the amount of visible ambient light from the calculated amount of incident ambient light. This will be necessary even in the case the plurality of detectors 4 are sensitive to visible light, since frequently the sensitivity curve for a detector 4 differs from the illuminance curve of the human eye.

The control unit 6 may also be configured to instruct the processor 8 to calculate a brightness value which may be used to adjust the brightness of the transmissive panel dependent on the amount of ambient light incident on the panel. This may be useful in cases where the transmissive panel is located above a backlight-powered display or where such a display is integrated with the transmissive panel. In this way power may be saved.

It shall be mentioned that in a normal case when measuring the ambient light level, the control unit 6 is configured to instruct the emitting control unit 3A to switch off all emitters and to instruct the detector control unit 5A to read out output values from the detectors. It is not necessary for the control unit 6 to instruct the reading out of all detector values. It may be sufficient to read out a few detector values which are sufficient to establish the level of ambient light incident on the transmissive panel 1.

Depending on implementation, the control unit 6 may instruct the detector control unit 5A to read out detector output values with a certain sampling rate which is chosen such that a sufficient number of sampling values are available from which an essentially accurate identification of the light signal and thus of the one or more ambient light sources may be performed. According to one variant, the control unit 6 may perform a sampling of the light-sensing element output values with sampling frequencies ranging from a couple of kHz to several hundred kHz, where electric signal values after every reading are composed into a signal vector. The sampling frequency and the length of the signal vector chosen will determine which frequencies can be used to classify the one or more ambient light sources.

In the discussion above, it was assumed that no surface contamination is present on the upper surface 1a of the transmissive panel 1. Usually however, there will be always some form of finger prints, smears, dust or other types of surface contaminations present on the upper surface 1a. These can be either modeled as being evenly distributed over the entire upper surface 1a of the transmissive panel or to be evenly distributed in certain sub-areas of the panels. In both cases the ambient light incident onto the contaminated surface will be scattered differently from the surface and into the transmissive panel which will affect the amount of light detected by the plurality of detectors 4. If the surface contamination is distributed evenly over the entire first surface 1a, then the control unit 6 may instruct the processor 8 to add a correction factor to each value in the signal vector. In case the contamination distribution is not even over the entire surface of the transmissive panel, i.e. there is a significant difference in the amount of ambient light registered between a first group of detectors 4 and a second group of detectors 4, then the control unit 6 may divide the transmissive panel into sub-areas each with associated detectors. The control unit 6 may then instruct the processor to add a sub-area dependent correction factor to detector output values belonging to detectors of the specific sub-area in question. The correction factor may be a simple constant or a known linear or non-linear relation.

FIG. 7 illustrates a flowchart of an embodiment of a method according to the present invention. In this embodiment we use light-sensitive elements with main sensitivity in the infrared spectrum. However, it should be emphasized that the embodiment in FIG. 7 would equally hold true for light-sensitive elements having their main sensitivity in the visible domain.

At step 300, a touch-sensitive apparatus, such as the touch-sensitive apparatus from FIG. 1 receives light signals at its array of light-sensitive elements. As mentioned earlier, the array of light-sensitive elements may be sensitive to infrared light or light in the visible spectrum.

Thereafter, at step 310, the light signals are converted into electrical signals by the detectors, amplified and converted into their digital counterparts by the detector control unit 5A.

Besides the known conversion from optical to electrical signal in the light-sensing elements, the amplified and A/D-converted output electrical signals from the light-sensing elements are at step 320 sampled into a signal vector representative of the ambient light signals incident on the touch-sensing apparatus. The sampling may involve reading output signal values from all light-sensing elements in the array or only a plurality of the light-sensing elements. It may be added that these output values may be read out during a time interval during which light-emitting elements in the touch-sensitive apparatus are switched off.

Although not illustrated by the flow chart in FIG. 7, the reading out and sampling of the output values from all or a part of the light-sensitive elements in the detector array may occur during a set of time intervals, i.e. continuously. Also possible is to read and sample the output values during time intervals which may be predefined or user-defined.

At step 330, the signal vector from step 320 is combined with a template signal vector or characteristic signal matrix in order to extract a feature vector which may have one or more features representative of one or more known ambient light sources. These features may be characteristic frequencies present in an ambient light source, characteristic time-related behavior of light from an ambient light source or some other signal characteristic which uniquely defines an ambient light source. One way to extract a feature vector at step 330 may be to perform a correlation operation between the signal vector and the one or more characteristic signal vectors or with a characteristic signal matrix in which the columns are represented by the characteristic signal vectors for each known ambient light source. Another possibility is to perform a convolution operation between the signal vector and the one or more characteristic signal vectors for each known ambient light source and thereby extract the feature vector representative of the signal characteristics of the light incident from the one or more ambient light source onto the touch-sensitive apparatus.

It should be mentioned that while the conversion of the light signals received in step 310 is performed in the time domain, the signal vector at step 320 may be formed in the time or frequency domain. One possible way to form the signal vector at step 320 may be to perform an FFT-operation on the time domain signal vector. The principles of the FFT-algorithm are known and will not be elaborated further in this description.

In case the signal vector is formed in the frequency domain, the operations described for step 330 will then be performed in the frequency domain as well.

It should also be mentioned that there are more possible feature extraction methods than correlation or convolution which are mentioned in the earlier paragraph and the above two simply serve as examples to illustrate the underlying principles of the present invention.

At step 340 the feature vector extracted at the previous step is classified in order to obtain information on which type or types of ambient light sources are illuminating the touch-sensitive apparatus. Without going into too much detail any known pattern recognition algorithm may be used to perform this operation. For example, a branch metric algorithm may be used which compares the extracted feature vector with a plurality of candidate signal vectors each corresponding to a specific class of ambient light sources, such as incandescent lamps, halogen lamps, LED-lamps and similar.

At step 350 the amount of infrared ambient light incident onto surface of the touch-sensitive panel is determined. In order to perform this operation, the ambient light incident on the one or more light-sensitive elements (which in this example are sensitive to IR light), such as the light-sensitive elements in FIG. 1, is determined first. This may be necessary, since there will most probably be a difference between the amount of ambient light incident onto the touch-sensitive apparatus and the amount of ambient light registered by the one or more light-sensitive elements in the touch-sensitive apparatus. One source of the discrepancy may be contaminations on the surface of the touch-sensitive plate stemming from fingerprints, smears, dust and other contamination sources. These contaminations lead to a different scattering of the ambient light through the light transmissive panel 1 and to the light-sensing elements. Also, the touch-sensitive apparatus as presented in FIGS. 1 and 2 relies upon the principle that some part of the ambient light will be scattered by the light transmissive panel and it is this part that may be registered by the one or more light-sensitive elements. One simple way of modeling the contamination of the touch-sensitive panel may be to assume that the contaminations are on average evenly distributed over the entire surface of the touch-sensitive panel. In this case the influence of the contaminations on the ambient light incident on the touch-sensitive panel may be taken account by using a correction factor C_{cont}. Multiplying the signal vector formed at step 320 by the correction factor will yield a corrected signal vector more realistically representing the real amount of ambient light incident on the touch-sensitive panel. Taking the absolute value of the thus corrected signal vector may then yield the average intensity value of the ambient light incident onto the surface of the touch-sensitive panel. In case of a more uneven distribution of the surface contamination over the upper surface of the light transmissive panel the model described earlier with the partition of the light transmissive panel into sub-areas may be applied. Please note that this corrected intensity value still represents the amount of infrared ambient light incident onto the touch-sensitive panel from one or more ambient light source.

Thus, it is necessary to transform the corrected average intensity value from step 350 into an intensity value of visible light seen by the human eye which takes into account the type or types of ambient light source which is generating the ambient light. Therefore, at step 360, the processor of the touch-sensitive apparatus, such as the processor 8 will calculate a conversion factor corresponding to the type of ambient light source identified at step 340. If several ambient light sources have been identified at step 340, then the processing unit may for example calculate a conversion factor for each ambient light source classified at step 340 and thereafter a general conversion factor which may be an average value.

It should be noted here that steps 350 and 360 are interchangeable, i.e. the calculation of a conversion factor or conversion factors for the ambient light source(s) detected may be performed on the signal vector from step 320 first and then the correction factor may be applied thereafter.

At step 370, the processor calculates from the corrected and converted intensity value of ambient light incident on obtained at steps 350 and 360 a brightness value for a display connected to the touch-sensitive apparatus of FIGS. 1 and 2. This value may then be used to adjust the brightness of the display to correspond to the ambient light level.

It should be noted that in the description of the steps in the flowchart in FIG. 7 it has been assumed that the light-sensing elements are mainly sensitive to infrared ambient light. However, the method may equally work with light-sensitive elements which are sensitive to visible light. In that case the conversion factor for the ambient light source or sources detected would again be calculated at step 360 to reflect the amount of light visible to the human eye.

1. A method for determining the amount of visible ambient light incident on a touch-sensitive apparatus comprising a first array of light sensing elements, the method comprising the steps:
receiving light signals at a plurality of light-sensing elements in the first array;
converting the light signals into electrical signals;
identifying at least one type of ambient light source from the signal by comparing features in the signal with characteristic features of one or more known light sources and;
obtaining information related to the amount of visible ambient light incident on the panel generated by the at least one type of ambient light source in relation to the amount of ambient light registered at the plurality of light-sensing elements.

2. A method according to claim 1, further comprising the step of forming a signal vector from the electrical signals by sampling the converted electrical signals from the plurality of light-sensing elements.

3. A method according to claim 1, wherein the step of identifying at least one type of ambient light source by comparing features in the signal comprises extracting a feature vector by comparing the signal vector with at least one template vector representative of a known ambient light source.

4. A method according to claim 3, further comprising classifying the feature vector obtained according to a closest match obtained during the comparison with a known ambient light source.

5. A method according to claim 1, wherein obtaining information related to the amount of visible ambient light incident on the panel comprises determining a correction factor indicative of the amount of scattering of the incident ambient light into the panel.

6. A method according to claim 1, where obtaining information related to the amount of visible light incident on the panel comprises determining a conversion factor indicative of the amount of visible light incident on the panel in relation to the amount of ambient light detected by the one or more light-sensing elements.

7. A method according to claim 1, further comprising the step calculating a brightness value from the information related to the amount of visible light incident on the panel.

8. A method according to claim 7, further comprising compensating the brightness of the panel using the brightness value.

9. A method according to claim 1, further comprising the step of generating light signals in a plurality of light-emitting elements belonging to a first array of light-emitting elements in the touch-sensitive apparatus during a first time period and receiving ambient light signals at the plurality of light-sensing elements during a second time period where the light-emitting elements are switched off.

10. A method according to claim 1, further comprising:
generating light signals in a plurality of light-emitting elements belonging to a first array of light-emitting elements in the touch-sensitive apparatus during a first time period;
receiving the light signals during the first time period at a plurality of light-sensitive elements;
receiving ambient light signals at the plurality of light-sensitive elements during a second time period where the plurality of light-emitting elements are switched off.

11. A method according to claim 1, further comprising:
generating light signals in a plurality of light-emitting elements belonging to a first array of light-emitting elements in the touch-sensitive apparatus;
receiving the light signals at a plurality of light-sensitive elements and;
measuring energy of the light signal for a particular detection line received at each of the plurality of light-sensitive elements;
computing a relative change between the energy of the light signal for each particular detection line received at each of the plurality of light-sensitive elements and a reference energy value for the light signal for the particular detection line and;
determining touch data for the transmissive panel based on the relative change.

12. A touch-sensitive apparatus for determining the amount of visible ambient light incident onto a touch-sensitive panel of the apparatus, comprising:
a first array of light-sensing elements configured to convert incident ambient light signals into electrical signals;
a memory unit configured to store characteristic signal features for a plurality of known ambient light sources;
wherein
the touch-sensitive apparatus further comprises a processor configured to identify at least one type of ambient light source from the signal by comparing features in the signal with the stored characteristic signal features of the one or more known light sources and wherein the processor is further configured to relate the amount of visible ambient light incident on a touch-sensitive panel of the apparatus generated by the ambient light source identified by the processor.

13. A touch-sensitive apparatus according to claim 12, wherein the first array of light-sensing elements is sensitive to infrared light.

14. A touch-sensitive apparatus according to claim 12, wherein the first array of light-sensing elements is sensitive to visible light.

15. A touch-sensitive apparatus according to one of the claim 12, wherein the first array of light-sensing elements is arranged along the periphery of the light-sensitive apparatus.

16. A touch-sensitive apparatus for determining the amount of visible ambient light incident onto the apparatus, comprising:
a light transmissive panel defining a touch surface and an opposite surface,
an illumination arrangement comprising emitters configured to generate light into the panel, such that light is propagated in the panel by total internal reflection;
a first array of light-sensing elements configured to receive the light generated by the emitters and ambient light incident onto the touch surface of the panel and to convert the incident ambient signals light into electrical signals;
a memory unit configured to store characteristic signal features for a plurality of known ambient light sources,
wherein
the touch-sensitive apparatus further comprises a processor configured to identify at least one type of ambient light source from the signal by comparing features in the signal with the stored characteristic signal features of the one or more known light sources and wherein the processor is further configured to relate the amount of visible ambient light received by the plurality of light-sensing elements to the amount of visible ambient light incident on the transmissive panel and generated by the ambient light source identified.
